(19) United States
(12) Patent Application Publication
(10) Pub. No.: US 2018/0135351 A1
(43) Pub. Date: May 17, 2018

(54) Window Shade

(71) Applicant: Brent Walker, San Diego, CA (US)

(72) Inventor: Brent Walker, San Diego, CA (US)

(21) Appl. No.: 15/870,898

(22) Filed: Jan. 13, 2018

Related U.S. Application Data
(63) Continuation-in-part of application No. 29/546,238, filed on Nov. 20, 2015, now abandoned.
Application No. 29/546,238 is a continuation-in-part of application No. 29/492,983, filed on Jun. 4, 2014, now abandoned.
Application No. 29/492,983 is a continuation-in-part of application No. 13/423,070, filed on Mar. 16, 2012, now Pat. No. 8,997,824.
(60) Provisional application No. 61/435,322, filed on Jan. 23, 2011.

(51) Int. Cl. E06B 9/264; E06B 9/72

(52) U.S. Cl. CPC E06B 9/264; E06B 2009/2429; E06B 9/72

(57) ABSTRACT

A window covering specially designed and configured to indoor residential shutters is disclosed. The window cover is deployed and stowed via a spool and provides a user with more control over light transmission, solar transmission and view through properties, as desired. In a preferred embodiment, a rectilinear housing hides the fabric cover in its stowed position and also houses a small electric motor. Also, the fabric covering is provided at a rear to a widow shutter having adjustable slats.

### PRIORITY CLAIM

This patent application is a continuation-in-part application containing subject matter that claims benefit of the priority date of pending U.S. Des. patent application Ser. No. 29/546,238 filed on Nov. 20, 2015, entitled SHUTTER FABRIC COVER which in turn is a continuation-in-part of U.S. Des. patent application Ser. No 29/492,983 filed on Jun. 4, 2014 entitled SHUTTER FABRIC COVER, which in turn is a continuation-in-part application of U.S. patent application Ser. No. 13/423,070 filed on Mar. 16, 2012 entitled, SOLAR SHUTTER, now U.S. Pat. No. 8,997,824, which claims benefit of priority date of U.S. Prov. Pat. App. Ser. No. 61/453,322 filed on Mar. 16, 2011; and accordingly, all of these patents or patent applications are hereby expressly incorporated by reference.

### BACKGROUND OF THE INVENTION

### Field of the Invention

The present invention pertains generally to devices for improving comfort and ambiance in domestic homes in addition to saving energy. More particularly, the invention relates to novel devices for solar screening to indoor shutters providing optimum lighting, privacy and climate control.

### Description of the Prior Art

Window coverings for privacy and light control have been known in various forms and designs. One relatively common form of window covering consists of vertical or horizontal slats usually made from metal or vinyl, also referred to as “blinds.” More specifically, Venetian blinds are a well liked design for regulating light and air in which horizontal (or vertical) slats are coupled by a chord and can rotate in unison nearly 180 degrees.

Several designs for window coverings have been proposed by Toti including U.S. Pat. No. 7,222,655, entitled “Window Covering System,” which was awarded patent protection in 2006. According to Toti, over the past several years, pleated shade system have become popular form of window treatment. One version of a pleated shade system is made available from Versol USA, Inc. under the trademark RIDEAU, utilizes a prepleated fabric with strong, permanently set pleats that pack very tightly. Toti further suggests that this and related designs are problematic in that the pleats retain residual tension much like a spring.

A more recent example employs a suction means to a window covering for attachment directly to a window, according to U.S. Pat. App. No. 2010/0116447, entitled “Blind for A Window,” to Thompson. In this example, the inventor seems to be most concerned with convenience and less concerned about whether the solution is aesthetically pleasing. Another example was set forth in U.S. Pat. No. 7,059,482, entitled “Window Covering Sample Display Device and Method,” to Reid et al, that was also awarded patent protection in 2006. Therein, window coverings are attached directly to their windows via suction cups mounted to a rear of the device. Further according to Reid and his co-inventors, the past several decades have been marked by tremendous growth in the types of window covering materials that are available to purchasers. Starting with roller shades and slatted horizontal blinds, the field of window coverings has blossomed to include a wide array of different types of coverings. These have included pleated shades, Roman shades, cellular shades and many others.

Also known to window coverings are shutters, or interior shutters more particularly. Interior shutters have horizontal louvers or slats to control sun light, air flow, visibility etc. Typically, the louvers or slats have their collective angle controlled by a tilt bar. Additionally, interior shutters may hinge on either side of a window so that they can be opened to allow full light access. Most interior designers would consider these shutters to be aesthetically pleasing to the inside environment providing a plantation or European style atmosphere.

One problem with indoor shutters is that they can provide an annoying glare even when fully closed due to light rays through cracks. Also, as with some other forms of window coverings, lines of glare, such as that on a television or computer screen, can be annoying even when sun light is less than its peak intensity.

Accordingly, it is an object of the present invention to provide a window covering system to shutters that artfully combines the hard look of a shutter with the soft elegance of fabric. It is a further object of the present invention to provide a window covering system wherein many different fabrics could be chosen to provide a variety of pattern/color options as well as different light and solar transmission, and view through properties. It is still further an object of the present invention to provide a window covering system that can be easily manipulated and changed based on the particular desires of a user at a particular time. Still further, it is an object of the present invention to provide a fabric cover that can be deployed when desired and stowed when not in use. It is yet further an object of the present invention to provide a window covering for interior shutters that is relatively easy to manufacture and comparatively cost effective.

### BRIEF SUMMARY OF THE INVENTION

The present invention specifically addresses and alleviates the above mentioned deficiencies associated with the prior art. More particularly, the present invention in a first aspect, is directed to an improved window shutter, or rather a window shade device, for light transmission and climate control comprising a window shutter, the window shutter comprising: a four-sided frame for positioning about an inside of a window frame; a plurality of slats rotatably coupled to the frame, the plurality of slats having an open position and a closed position; and a covering fabric, configured to the frame, the covering fabric providing at least a partial filter for light transmission through the window shutter.

Further to the window shutter and the slats, a vertical link bar is coupled to a leading edge of each of the plurality of slats for transitioning the plurality of slats from the open position to the closed position. Hence, in the open position the covering fabric is positioned at an opposite edge with respect to the leading edge of each of the plurality of slats. Accordingly, the fabric cover can be made positioned adjacent to a window pane while the vertical link bar is positioned at the interior of a home.

The window shade device for light transmission and climate control in this aspect is additionally characterized in that the four-sided frame comprises: an outer frame having four sides; and an inner frame (or, door) having four sides, wherein the inner frame is hingedly connected to the outer frame, and further wherein the covering fabric is coupled to the outer frame.

The window shade device for light transmission and climate control in this aspect, is additionally characterized as comprising a cylindrical rotatable spool configured at an upper portion of the four sided frame, wherein the covering fabric is configured at an upper portion of the outer frame via the spool positioned horizontally, and wherein the covering fabric extends from the spool in a deployed position, and wherein the covering fabric is wound about the spool in a stowed position.

Still further in this first aspect, the invention is characterized as in that it comprises an electric motor coupled to and providing rotational motion to the spool; a reinforcement frame is coupled about the outer frame at a rear thereof; and a cylindrical battery pack, the pack configured as a housing for one or more battery devices. The cylindrical battery pact is further attached a lateral side of the four-sided frame; and the battery pack is further attached adjacent to the reinforcement frame.

Yet still further, the invention in this aspect may be characterized in that it additionally comprises a rectilinear housing for containing and covering the spool and electric motor.

In a second aspect, the invention is characterized as a window shade device for light transmission and climate control that comprises: a four sided frame; a cylindrical rotatable spool configured horizontally at an upper portion of the four sided frame; and a covering fabric providing at least a partial transmission of light, the covering fabric extending downwardly from the spool in a deployed position, and the covering fabric wound about the spool in a stowed position.

The window shade device for light transmission and climate control in this second aspect is additionally characterized as comprising: an electric motor coupled to and providing rotational motion to the spool; and a cylindrical battery pack, the pack configured as a housing for one or more battery devices. Also importantly, the battery pack is configured to a lateral side of the four sided frame; and the window shade device further has a rectilinear housing for containing the spool and electric motor.

These, as well as other advantages of the present invention will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a hinged interior window shutter of the present invention with a fabric cover at a rear thereof;

FIG. 2 is a top plan view thereof;

FIG. 3 is a profile view of the first preferred embodiment;

FIG. 4 is an elevational view of the first preferred embodiment;

FIG. 5 is an enlarged perspective illustration of FIG. 1 having a hinged shutter door in an open position;

FIG. 6 is a rear perspective view of a window cover in a preferred position; and

FIG. 7 is a second rear perspective view of the invention with the fabric cover in a stowed position.

### DETAILED DESCRIPTION OF THE PREFERRED EMBODIMENTS

Various inventive features are described below that can each be used independently of one another or in combination with other features.

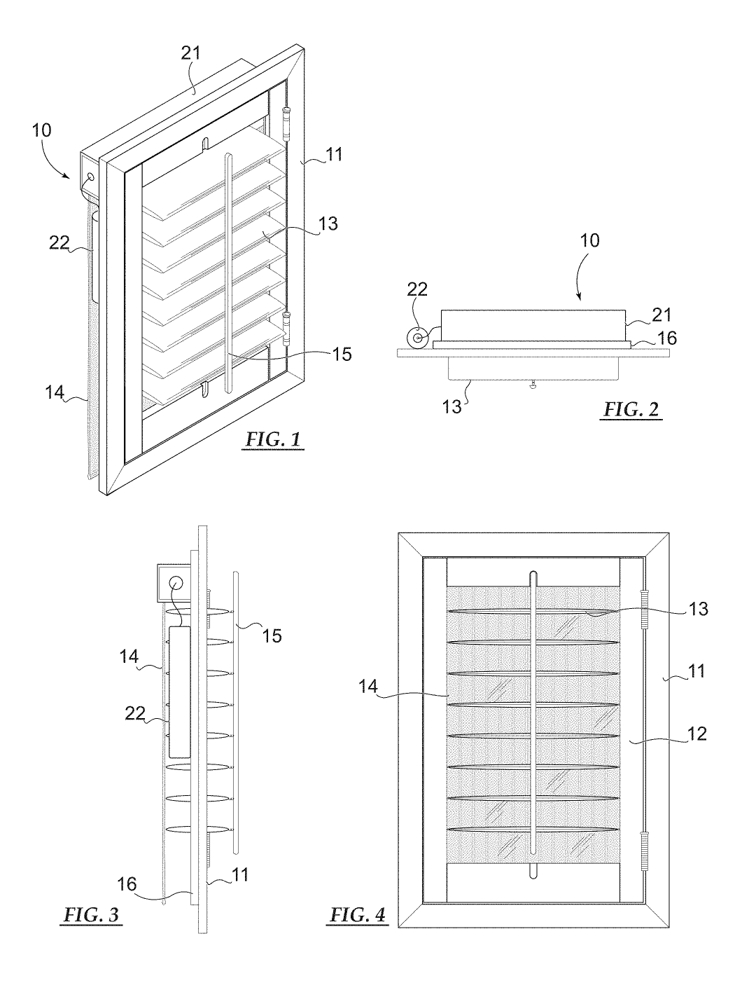

Initially, with reference to FIG. 1, a preferred device and system 10 of the present invention is illustrated in perspective. Illustrated is a window shade 10 configured window shutter having a four-sided outer frame 11 configured about an inner frame 12, or alternatively a door 12. Also in the preferred embodiment, the inner frame is also a hinged window shutter door having a plurality of slats 13 rotatably coupled to the door 12. As shown throughout the illustrations, the slats 13 are fully open and light is filtered through a window covering 14 of the present invention. It should be appreciated that light and privacy control can be achieve by translating the tilt bar 15 to reposition the slats 13.

FIG. 2 shows a top plan view of the device and system 10 particularly showing a reinforcement frame 16 situated behind the outer frame 11. Housing 21 is provided to stow the fabric cover 14 when not deployed.

With regard to FIG. 3, a profile view is shown with the louvers/slats 13 fully open. Optionally, the slats 13 removeably touch the window covering 14 such that they assist the covering 14 to be taut in the open position. Importantly, the slats 13 are rigid, made from wood for example, to assist this affect. The tilt bar 15 is also comprised of rigid material. Further, the window covering 14 does not impede shutter 10 operation to any degree. The coverings 14 comprise high quality textured fabric providing a soft elegance to the traditional hard look of an interior shutter. Also in a preferred embodiment, the fabric cover 14 is semi-transparent and a partial light filter. A complete light filter would be largely redundant and undesirable since the shutter slats 13 could simply be closed for that desired effect.

Yet further is shall be appreciated the shutter device 10 of the present invention can be easily configured inside an existing window frame comprising typical plane glass usual to residential applications. Hence, the plane glass would be situated behind the fabric cover 14 in the profile FIG. 3 so that the fabric cover 14 would be between the shutter frame 11 and the actual plane glass.

FIG. 4 illustrates a front elevational view of the first preferred invention embodiment of the window cover 14 configured to a window shutter 10. As further contemplated herein, various coverings 14 having different colors and screening properties are optional to a user. For example, a minimum or maximum solar or light transmission may be optimal depending upon summer or winter seasonal weather conditions. Further, light transmission properties would depend on the amount of natural light desired by the user based on subjective preference.

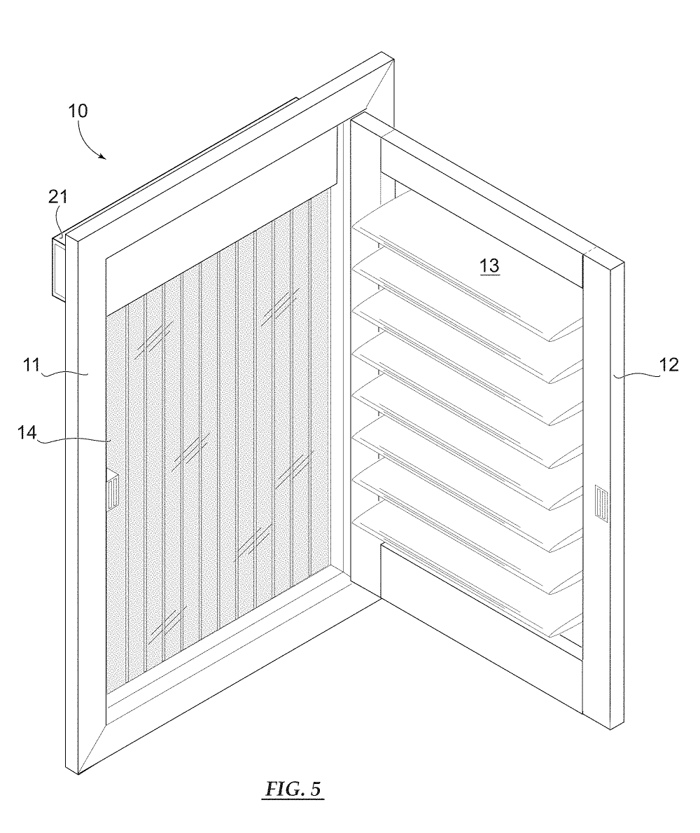

FIG. 5 provides an enlarged perspective illustration similar to FIG. 1 however showing the hinged shutter door 12 in an open position. In this preferred position, the window shutter device and system 10 provides a smooth and elegant feel to an interior room, particularly with the cover 14 in full view (FIG. 5) and fully deployed. FIG. 5 further illustrates how a covering 14 of the present invention will not affect indoor shutter 12, 13, 15 operation to the user at the window interior.

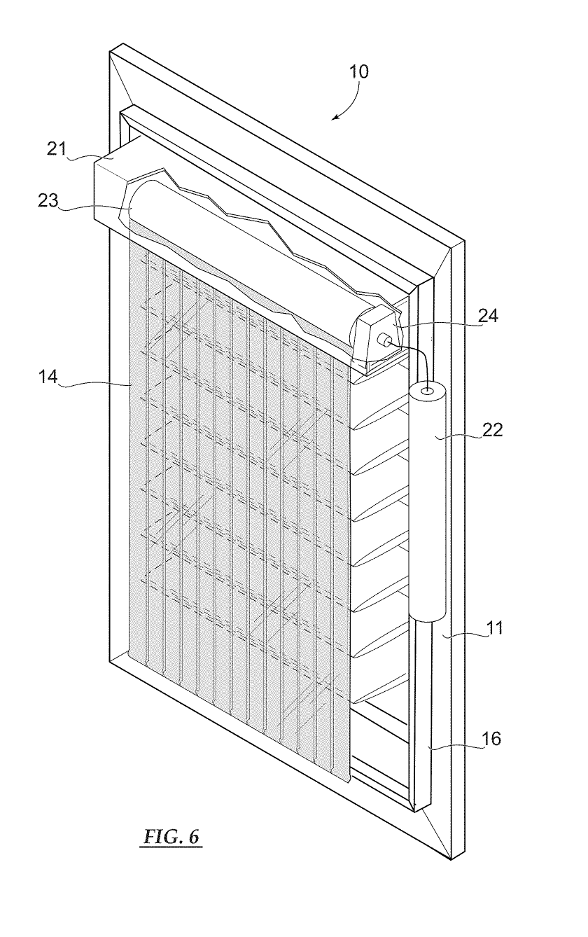

Regarding FIG. 6, a rear perspective view of the preferred embodiment is shown with the window covering 14 again fully deployed, further wherein a portion of a spool housing 21 is removed to reveal internal contents. Specifically, the rectilinear housing 21 is provided to contain a rotatable and cylindrical spool 23 of the invention embodiment. The housing 21 is attached to an upper portion of the outer shutter frame 11 with the reinforcement frame 16 coupled around the housing. Also further, the cylindrical spool 23 is attached at an upper portion of the outer frame 11, with the housing 21 constructed around the spool 23. In turn, the spool 23 is coupled to an electric motor 24 providing rotational motion to the spool to deploy the covering fabric 14, or with the motor 24 in the reverse direction, wind up and store the covering fabric 14 within the housing 21. It shall be appreciated that the motor may be actuated by any known means, such as contact switch, or remote ratio signals, or the like.

Further as shown in the illustrations, the cover 14 could be easily removed and replaced with another having a different color, pattern, light, or solar transmission properties. The solar shutter system comprises an indoor shutter 10 to be configured to a window frame, the indoor shutter 10 further comprising an outside frame 11 hingedly coupled to an inside frame 12, the inside frame 12 comprising louvers 13, and a window covering 14 attached to an upper portion of the outer frame 11.

Additionally regarding FIG. 6, a cylindrical battery pack 22 is provided outside of the spool housing 21 at a lateral side of the outer frame 11 and adjacent to reinforcement frame 16 (FIG. 2). In a preferred embodiment, the pack 22 is configured to house one or more battery devices. The battery pack 22 provides power to and completes an electrical circuit with the motor 24. And, it shall be appreciated that the battery pack 22 could be configured inside the rectilinear housing.

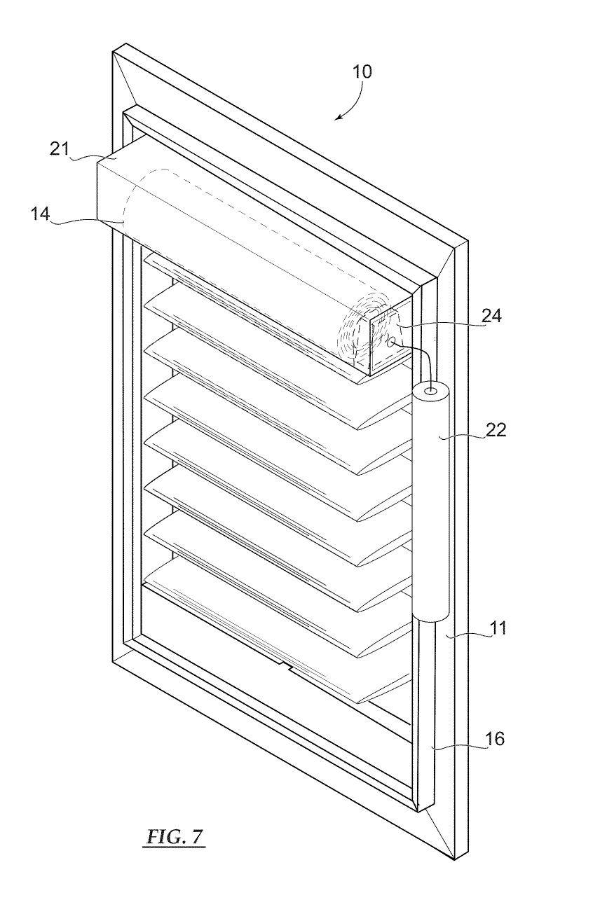

FIG. 7 is provided to illustrate the fabric cover 14 in a stowed position, however with dashed lines. The cover 14 will be completely hidden from view as it is secured within the spool and motor housing 21.

It should be understood, of course, that the foregoing relates to exemplary embodiments of the invention and that modifications may be made without departing from the spirit and scope of the invention as set forth in the following claims.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Window Shade as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A window shade device for light transmission and climate control comprising a window shutter, the window shutter comprising:
a four-sided frame for positioning about an inside of a window frame;
a plurality of slats rotatably coupled to the frame, the plurality of slats having an open position and a closed position;
a covering fabric, configured to the frame, the covering fabric providing at least a partial filter for light transmission through the window shutter; and
a vertical link bar coupled to a leading edge of each of the plurality of slats for transitioning the plurality of slats from the open position to the closed position and wherein in the open position the covering fabric is positioned at an opposite edge with respect to the leading edge of each of the plurality of slats.

2. The window shade device for light transmission and climate control of claim 1, the four-sided frame comprising:
an outer frame having four sides; and
an inner frame having four sides, wherein the inner frame is hingedly connected to the outer frame, and further wherein the covering fabric is coupled to the outer frame.

3. The window shade device for light transmission and climate control of claim 1, further comprising a cylindrical rotatable spool configured at an upper portion of the four sided frame, wherein the covering fabric is configured at an upper portion of the outer frame via the spool positioned horizontally, and wherein the covering fabric extends from the spool in a deployed position, and wherein the covering fabric is wound about the spool in a stowed position.

4. The window shade device for light transmission and climate control of claim 3, further comprising:
an electric motor coupled to and providing rotational motion to the spool;
a reinforcement frame coupled to and about the outer frame at a rear thereof; and
a cylindrical battery pack, the pack configured as a housing for one or more battery devices, the cylindrical battery pact further, the battery pack attached a lateral side of the four-sided frame, the battery pack further attached adjacent to the reinforcement frame.

5. The window shade device for light transmission and climate control of claim 3, further comprising a rectilinear housing for containing and surrounding the spool and electric motor.

6. The window shade device for light transmission and climate control of claim 5, wherein the reinforcement frame attaches to the rectilinear housing at an upper portion thereof.

7. The window shade device for light transmission and climate control of claim 1 wherein the plurality of slats removably touch the fabric cover to assist the fabric cover to remain taut, further wherein the stats and tilt bar are both made from ridged material.

8. A window shade device for light transmission and climate control comprising:
a four sided frame;
a cylindrical rotatable spool configured horizontally at an upper portion of the four sided frame; and
a covering fabric providing at least a partial transmission of light, the covering fabric extending from the spool in a deployed position, and the covering fabric wound about the spool in a stowed position.

9. The window shade device for light transmission and climate control of claim 6, further comprising:
an electric motor coupled and providing rotational motion to the spool; and
a cylindrical battery pack, the pack configured as a housing for one or more battery devices.

10. The window shade device for light transmission and climate control of claim 7, wherein the battery pack is configured to a lateral side of the four sided frame and wherein the window shade device further comprises a rectilinear housing for containing the spool and electric motor.
